(19) United States
(12) Patent Application Publication
(10) Pub. No.: US 2026/0222035 A1
(43) Pub. Date: Jul. 30, 2026

(54) BEAM REPORT WITH AI CAPABILITY

(71) Applicant: LENOVO (BEIJING) LIMITED, Beijing (CN)

(72) Inventors: Bingchao LIU, Beijing (CN); Jianfeng WANG, Beijing (CN); Congchi ZHAN, Shanghai (CN); Shuigen YANG, Shanghai (CN)

(21) Appl. No.: 19/148,162

(22) PCT Filed: Jan. 20, 2023
(86) PCT No.: PCT/CN2023/073398

§ 371 Date: Jul. 15, 2025

(51) Int. Cl. H04B 7/06; H04B 17/318; H04L 41/16

(52) U.S. Cl. CPC H04B 7/0626; H04B 17/328; H04L 41/16

(57) ABSTRACT

Methods and apparatuses for beam report with AI/ML capability are disclosed. In one embodiment, a UE comprises a transceiver; and a processor coupled to the transceiver, wherein the processor is configured to receive, via the transceiver, a configuration for a CSI report, wherein, the configuration is associated with a measurement resource set and a prediction resource set; and transmit, via the transceiver, the CSI report including a resource type indication field to indicate the reported resources are measured resources selected from the measurement resource set or predicted resources selected from the prediction resource set.

### FIELD

The subject matter disclosed herein generally relates to wireless communications, and more particularly relates to methods and apparatuses for beam report with AI/ML capability.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Channel State Information (CSI), Channel State Information Reference Signal (CSI-RS), CSI-RS resource indicator (CRI), Reference Signal Receiving Power (RSRP), Layer 1 Reference Signal Receiving Power (L1-RSRP), synchronization signal (SS), Physical Broadcast Channel (PBCH), SS/PBCH Block (SSB), primary synchronization signal (PSS), secondary synchronization signal (SSS), Machine learning (ML), artificial intelligence (AI), base station (BS), Deep Neural Network (DNN), Recurrent Neural Network (RNN), SSB resource indicator (SSBRI), quasi colocation (QCL), 3rd Generation Partnership Project (3GPP), Technical Specification (TS).

In NR Release 15, a CSI reporting setting configured by higher layer parameter ‘CSI-ReportConfig’ is linked to one Resource Setting for channel measurement which may have multiple CSI-RS resource sets each of which may include one or more CSI-RS resources. One or more CSI-RS resource sets selected from the Resource Setting are linked with one ‘CSI-ReportConfig’. From the UE point of view, the CSI-RS resources included in the linked CSI-RS resource set(s) are to be received by the UE for the channel measurement.

A higher layer parameter ‘reportQuantity’ contained in ‘CSI-ReportConfig’ IE configures the UE with the CSI quantities (parameters) to be reported. The parameters may include but not limited to CSI-RS resource indicator (CRI) and layer 1 Reference Signal Received Power (L1-RSRP) (e.g., when ‘reportQuantity’ is set to ‘cri-RSRP’).

CRI is used to indicate a CSI-RS resource to derive the corresponding CSI parameter(s) (e.g., L1-RSRP). That is, each CRI is used to indicate one CSI-RS resource from the CSI-RS resources included in the linked CSI-RS resource set(s) in the Resource Setting, based on which a L1-RSRP is measured.

L1-RSRP for CSI-RS is defined as the linear average over the power contributions (in [W]) of the resource elements of the antenna port(s) that carry CSI-RSs configured for RSRP measurements within the considered measurement frequency bandwidth in the configured CSI-RS occasions. In other words, one L1-RSRP represents the received power of one CSI-RS resource indicated by a CRI. The one L1-RSRP can be said to correspond to the CRI.

In addition to being based on CSI-RS resource, L1-RSRP can be measured based on SSB (SS/PBCH block) resource. Each SS/PBCH block, from which UE can obtain the system information, contains a PSS (primary synchronization signal), SSS (secondary synchronization signal), and PBCH (physical broadcast channel) where each of them is transmitted by the gNB using a same spatial Tx beam. The PSS, SSS and PBCH together are referred to as synchronization signal block (SSB). When the ‘reportQuantity’ contained in ‘CSI-ReportConfig’ IE is set to ‘ssb-Index-RSRP’, the ‘CSI-ReportConfig’ is linked to one Resource Setting for channel measurement which may have multiple SSB resource sets each of which may include one or more SSB resources. One or more SSB resource sets selected from the Resource Setting are linked with one ‘CSI-ReportConfig’. From the UE point of view, the SSB resources included in the linked SSB resource set(s) are to be received by the UE for the channel measurement. SSBRI is used to indicate a SS/PBCH block resource (may be referred to as “SSB resource”) to derive the corresponding CSI parameter(s) (e.g., L1-RSRP). That is, each SSBRI is used to indicate one SSB resource from the SSB resources included in the linked SSB resource set(s) in the Resource Setting, based on which a L1-RSRP is measured. L1-RSRP for SSB is defined as the linear average over the power contributions (in [W]) of the resource elements that carry secondary synchronization signals. One L1-RSRP represents the received power of one SSB resource indicated by a SSBRI. The one L1-RSRP can be said to correspond to the SSBRI.

As a whole, when a ‘CSI-ReportConfig’ is linked to one Resource Setting for channel measurement, and the ‘reportQuantity’ is set to ‘cri-RSRP’ or ‘ssb-Index-RSRP’, the UE would report CRI or SSBRI and L1-RSRP measured based on the CSI-RS or SSB resource indicated by the CRI or SSBRI (may be referred to as “L1-RSRP corresponding to the CRI or SSBRI”). In particular, a measured L1-RSRP is a received power of the CSI-RS or SSB resource indicated by the CRI or SSBRI. Each CSI-RS resource or SSB resource corresponds to a DL Tx beam.

Machine learning (ML) is a method to achieve artificial intelligence (AI). In the following description, they are described as AI/ML. AI/ML based beam prediction is studied in 3GPP NR Release 18 to enhance the system performance and/or to reduce beam management complexity and overhead, especially for the case that larger number of beams are adopted for the base station (BS) and/or the UE. One potential use case is that an AI/ML function (which may also be referred to as “AI/ML inference function”) is deployed in a UE, and the UE can predict a beam in beam set A based on the measurement of beams in beam set B, where beam set A comprises of a larger number of beams while beam set B comprises of a small number of beams. Another potential use case is that an AI/ML function is deployed in a UE, and the UE can predict, by employing the AI/ML function, the best K (K>=1) beams for F_{P} (F_{P}>=1) future instances based on historical measurement results. The UE shall do the beam prediction based on network configuration (e.g., configuration from gNB) and report the predicted beams to gNB.

This invention targets enhancements on the beam report with AI/ML function.

### BRIEF SUMMARY

Methods and apparatuses for beam report with AI/ML capability are disclosed.

In one embodiment, a UE comprises a transceiver; and a processor coupled to the transceiver, wherein the processor is configured to receive, via the transceiver, a configuration for a CSI report, wherein, the configuration is associated with a measurement resource set and a prediction resource set; and transmit, via the transceiver, the CSI report including a resource type indication field to indicate the reported resources are measured resources selected from the measurement resource set or predicted resources selected from the prediction resource set.

In some embodiment, the configuration is associated with an AI/ML function at least for spatial domain resource prediction, if the resource type indication field indicates that the reported resources are predicted resources, the reported resources are predicted from the prediction resource set by the AI/ML function; and if the resource type indication field indicates that the reported resources are measured resources, the reported resources are resources in the measurement resource set that have top measured L1-RSRPs. In addition, if the resource type indication field indicates that the reported resources are predicted resources, a bitwidth of each CRI or SSBRI field in the CSI report is determined by the number of resources configured in the prediction resource set, and if the resource type indication field indicates that the reported resources are measured resources, the bitwidth of each CRI or SSBRI field in the CSI report is determined by the number of resources configured in the measurement resource set.

In some embodiment, the configuration is associated with an AI/ML function at least for temporal domain resource prediction, if the resource type indication field indicates that the reported resources are predicted resources, the reported resources are the predicted resources predicted by the AI/ML function for each of F future time instances, where F is an integer that is 1 or more; and if the resource type indication field indicates that the reported resources are measured resources, the reported resources are resources in the measurement resource set that have top measured L1-RSRPs.

In some embodiment, the configuration is associated with an AI/ML function that can output predicted resources without predict L1-RSRPs of the predicted resources, the processor is further configured to receive, via the transceiver, a configuration for a second CSI report which is associated with a second measurement resource set. The number of resources configured in the second measurement resource set may be the same as the number of reported resources in the CSI report. The processor may be further configured to receive, via the transceiver, within a duration since the transmission of the CSI report, a control signal triggering the second CSI report, wherein, the resources configured in the second measurement resource set are QCLed with the reported resources in the CSI report.

In some embodiment, the processor is further configured to transmit, via the transceiver, information on the type(s) of the AI/ML function(s) equipped by the UE.

In some embodiment, the measurement resource set and the prediction resource set are the same resource set.

In some embodiment, the configuration is further associated with a quantization indication.

In another embodiment, a method performed at a UE comprises receiving a configuration for a CSI report, wherein, the configuration is associated with a measurement resource set and a prediction resource set; and transmitting the CSI report including a resource type indication field to indicate the reported resources are measured resources selected from the measurement resource set or predicted resources selected from the prediction resource set

In still another embodiment, a base unit comprises a transceiver; and a processor coupled to the transceiver, wherein the processor is configured to transmit, via the transceiver, a configuration for a CSI report, wherein, the configuration is associated with a measurement resource set and a prediction resource set; and receive, via the transceiver, the CSI report including a resource type indication field to indicate the reported resources are measured resources selected from the measurement resource set or predicted resources selected from the prediction resource set.

In yet another embodiment, a method performed at a base unit comprises transmitting a configuration for a CSI report, wherein, the configuration is associated with a measurement resource set and a prediction resource set; and receiving the CSI report including a resource type indication field to indicate the reported resources are measured resources selected from the measurement resource set or predicted resources selected from the prediction resource set.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates the principle of AI/ML based beam prediction in spatial domain;

FIG. 2 illustrates a first example of the AI/ML Model for temporal beam prediction;

FIG. 3 illustrates a second example of AI/ML Model for temporal beam prediction;

FIG. 4 is a schematic flow chart diagram illustrating an embodiment of a method at UE side;

FIG. 5 is a schematic flow chart diagram illustrating an embodiment of a method at network side; and

FIG. 6 is a schematic flow chart diagram illustrating an embodiment of another method at UE side;

FIG. 7 is a schematic flow chart diagram illustrating an embodiment of another method at network side; and

FIG. 8 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

FIG. 1 illustrates the principle of AI/ML based beam prediction in spatial domain. An AI/ML model can be implemented by a Deep Neural Network (DNN) or a Recurrent Neural Network (RNN). As shown in FIG. 1, an AI/ML model which can be used for beam prediction based on AI/ML inference function (which may be abbreviated as “AI/ML function” or referred to as “AI/ML model”) is deployed at the UE or network (e.g., gNB) side. The measurement results (e.g., the L1-RSRP) based on a measurement beam set (e.g., measurement beam set B), which includes some number of beams, are set as the input of the AI/ML model. The measurement beam set consists of a set of measurement beams. Each beam can be represented by a CSI-RS resource or a SSB resource. And the beam index can be represented by a CSI-RS resource index (CRI) or a SSB resource index (SSBRI). Accordingly, the measurement beam set can be referred to as measurement resource set. The AI/ML model, based on the input, according to AI/ML inference algorithm, performs beam prediction of another prediction beam set (e.g., prediction beam set A) (or prediction resource set), which includes a larger number of beams. Incidentally, the output of the AI/ML model can be predicted results of any number of beams (e.g., the best 2 beams with the corresponding predicted L1-RSRP) contained in the beam prediction set A. The best 2 beams mean that the predicted L1-RSRPs of the 2 beams are the best (the largest and the second largest) among the predicted L1-RSRPs of the beams in the prediction beam set.

An AI/ML Model in the UE that is used for temporal beam prediction performs beam quality prediction for F (F>=1) future instances based on the historical measurement results (e.g., on the latest K (K>=1) measurement instances) of the measurement beams by employing the time domain correlation. The AI/ML Model may be implemented by an RNN (Recurrent Neural Network) or DNN (Deep Neural Network) with a set of fixed weights, which can be updated with AI/ML Model update procedure. The detailed implementation of the AI/ML Model used for temporal beam prediction is out of the scope of this disclosure.

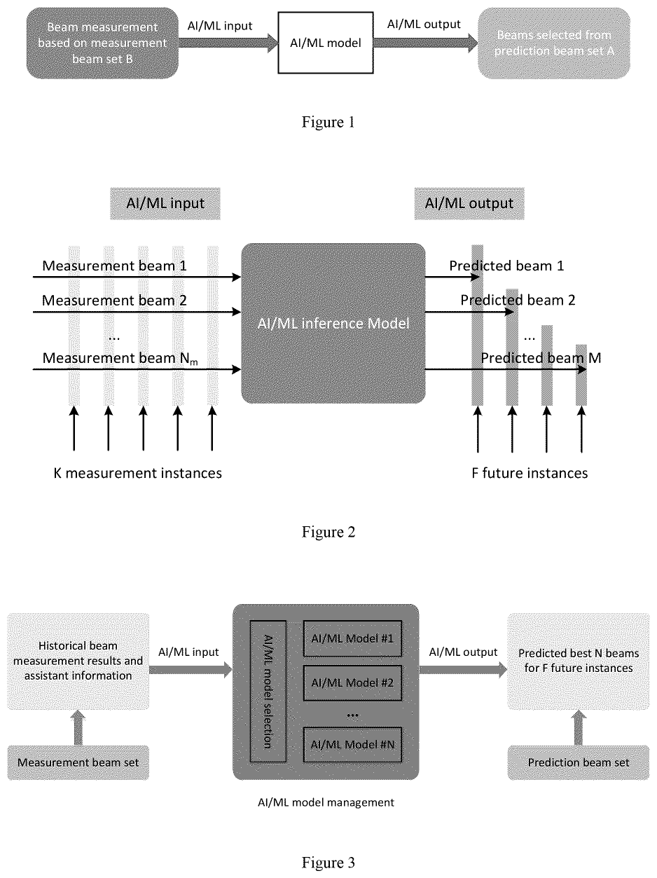

FIG. 2 illustrates a first example of the AI/ML Model for temporal beam prediction with AI/ML input and AI/ML output. A measurement beam set consists of a set of measurement beams. A prediction beam set consists of a set of beams for prediction. The input to the AI/ML Model is the historical (e.g., on measurement instances) beam measurement results (e.g., L1-RSRP) of the measurement beams within the measurement beam set. A measurement instance is a time instance at which the quality of each measurement beam is measured (or obtained). The output from the AI/ML Model is the predicted best K (K>=1) beams among the beams within the prediction beam set on F_{P} (F_{P}>=1) future instances. A future instance is a time instance that is after each of the measurement instances at which the beam measurement results are obtained. Each AI/ML Model requires a fixed input format (e.g., L1-RSRPs of a fixed number of measurement beams), and can output predicted best K beams (e.g., best K beams among the beams within the prediction beam set) for each of F (F<=F_{P}) future instances. A CSI report configuration which is configured by RRC parameter CSI-ReportConfig, i.e., a CSI reporting setting, for beam prediction shall be configured to satisfy the requirements of the AI/ML Model. If the AI/ML Model only has the temporal beam prediction function, the measurement beam set and the prediction beam set should be the same, i.e., both beam sets contain the same beams. If the AI/ML Model has both temporal and spatial domain beam prediction function, the measurement beam set and the prediction beam set can contain different beams, e.g., the prediction beam set has a larger number of beams while the measurement beam set has a small number of beams.

FIG. 3 illustrates a second example of AI/ML Model for temporal beam prediction, in which multiple AI/ML Models (e.g., AI/ML Model #1 to AI/ML Model #N) are provided in addition to an AI/ML Model selection function. The AI/ML Model selection function is used for selecting (allocating) an AI/ML Model from the multiple AI/ML Models for a certain beam prediction procedure. The multiple AI/ML Models and the AI/ML Model selection function can be collectively referred to as AI/ML Model management function.

A first embodiment relates to different AI/ML capabilities (e.g., different AI/ML functions).

As described above, the AI/ML function can be deployed at UE side and/or at network side (e.g., at gNB). An AI/ML function deployed at a UE can be referred to as that the UE is equipped with the AI/ML function.

If an AI/ML function is deployed at network side, no matter whether an AI/ML function is deployed at UE side, the network may determine to use the AI/ML function deployed at network side.

If one or multiple AI/ML functions are deployed at UE side, a UE capability on the AI/ML functions (e.g., the types of AI/ML functions deployed at UE) can be reported to the network (e.g., gNB). The AI/ML functions deployed at UE side may have different types listed as follows:
(1) an AI/ML function for spatial domain beam prediction (i.e., only for spatial domain beam prediction); and
(2) an AI/ML function for temporal domain beam prediction.

The AI/ML function for temporal domain beam prediction can be further divided into:
(2-1) an AI/ML function only for temporal domain beam prediction (which implies that it cannot be used for spatial domain beam prediction);
(2-2) an AI/ML function for both temporal domain beam prediction and spatial domain beam prediction.

From another point of view, the AI/ML function only for spatial domain beam prediction and the AI/ML function for both temporal domain beam prediction and spatial domain beam prediction can be collectively referred to as AI/ML function at least for spatial domain resource prediction. Similarly, the AI/ML function only for temporal domain beam prediction and the AI/ML function for both temporal domain beam prediction and spatial domain beam prediction can be collectively referred to as AI/ML function at least for temporal domain beam prediction.

For different types of the AI/ML functions, the formats of the beam reports, i.e., a CSI report configured with the high layer parameter ‘reportQuantity’ is set to ‘cri-RSRP’ or ‘ssb-Index-RSRP’, are also different.

Incidentally, one UE may be equipped with one or multiple AI/ML functions for the same or for different AI/ML functions. It means that the UE may report a UE capability with one or multiple AI/ML capabilities (i.e., one or multiple AI/ML functions with different types). That is, the UE reports all of the types of AI/ML function(s) equipped by the UE (or deployed at the UE).

Further, different AI/ML Models for the same AI/ML function may have different AI/ML output, which should be part of UE AI/ML capability reporting. For example, one AI/ML model for spatial domain beam prediction can output the predicted top K beams (e.g., by their beam IDs) and their corresponding predicted L1-RSRPs, while another AI/ML model for spatial domain beam prediction can only output the predicted top K beams but cannot output their corresponding predicted L1-RSRPs. The detail of the AI/ML model that only outputs the predicted top K beam IDs will be described in the fourth embodiment.

A second embodiment relates to beam report for AI/ML function(s) deployed at network side.

When AI/ML function(s) are deployed at the network side (e.g., at gNB), e.g., for spatial domain beam prediction, the gNB may configure or trigger a beam measurement and beam report procedure for the UE to obtain the measurement results on measurement beam set B to provide input to the AI/ML function deployed at the network side.

For example, the gNB configures or triggers a beam measurement and beam report procedure, i.e., a CSI report setting (or CSI report configuration) configured by a CSI-ReportConfig with the high layer parameter ‘reportQuantity’ is set to ‘cri-RSRP’ or ‘ssb-Index-RSRP’, for the UE to report a beam report, i.e., a CSI report containing CRI(s) and the corresponding L1-RSRP(s). In particular, the gNB configures a CSI-ReportConfig to the UE. The CSI report configuration is associated with a measurement beam set B consisting of a number of beams (e.g., 8 beams or 16 beams) for measurement. The UE, upon receiving the CSI report configuration for the CSI report and the CSI report being triggered, measures the beams (e.g., measure the L1-RSRPs of the beams) in the measurement beam set B, and reports the measurement results (i.e., the measured L1-RSRPs of the beams in the measurement beam set B) in the corresponding CSI report. Since the CSI report contains the measurement results of the beams, it can also be referred to as “beam report”. Incidentally, in the following description, L1-RSRP may be abbreviated as RSRP.

Note that each beam is configured by a CSI-RS resource or a SSB resource and the beam ID is represented by a CRI or a SSBRI. It means that the measurement beam set B can be also referred to as measurement resource set B consisting of a number of CSI-RS or SSB resources and each CSI-RS resource or SSB resource corresponds to a CRI or a SSBRI.

Differential RSRP based beam report specified in 3GPP TS38.214 and TS38.133 can be used. It means that, in the CSI report (i.e., beam report) reported by the UE, only the largest measured RSRP is reported by being quantized to a 7-bit value in the range [−140,−44] dBm with 1 dB step size, while the other measured RSRPs are reported with a differential value computed with 2 dB step size with a reference to the largest measured RSRP and quantized to a 4-bit value.

Table 1 provides a CSI report format for the CSI report according to the second embodiment, where N is the number of beams in the measurement beam set B.

TABLE 1

| CSI report number | CSI field |
|---|---|
| CSI report #n | CRI or SSBRI indicates the CSI-RS |
| | resource or SSB resource with largest |
| | measured RSRP |
| | RSRP#1 of the CSI-RS or SSB resource |
| | indicated by CRI or SSBRI |
| | Differential RSRP#1 |
| | . . . |
| | Differential RSRP#N-1 |

In Table 1, it is assumed that the measurement beam set consists of N beams (e.g., N CSI-RS or SSB resources) and the UE is configured to report the measurement results of all the beams in the measurement beam set B. As can be seen from Table 1, a first field is the CRI or SSBRI field indicating the CRI or SSBRI that indicates the CSI-RS or SSB resource with largest measured RSRP among the measured RSRPs of all the beams in the measurement beam set B. The bit length of the first field is determined by the number of beams (i.e., CSI-RS resources or SSB resources) contained in the measurement beam set B. The second field is the largest measured RSRP (e.g., quantized to a 7-bit value) corresponding to the CRI or SSBRI indicated in the first field. The differential RSRPs of the other CSI-RS resources or SSB resources (e.g., each is quantized to a 4-bit value) are reported in the following fields by an order (e.g., an ascending order) of CRI or SSBRI for the resources. Note that one RSRP is included corresponding to one CSI-RS or SSB resource with largest measured RSRP. So, differential RSRPs are included corresponding to the remaining N−1 CSI-RS or SSB resources in the measurement beam set B.

As described above, according to the legacy quantization scheme, the largest reported RSRP is defined by a 7-bit value in the range [−140,−44] dBm with 1 dB step size, and the differential RSRP is quantized to a 4-bit value, while the differential RSRP is computed with 2 dB step size with a reference to the largest measured RSRP value which is the largest reported RSRP in the same beam report. If the 7-bit RSRP and the 4-bit differential RSRP is sufficient to the quantization precision of the input to the AI/ML function deployed at network side, the legacy quantization scheme can be used.

According to a variety of the second embodiment, a new quantization scheme with higher quantization accuracy is proposed. The indication of higher quantization accuracy can be included in or associated with the CSI report configuration. The higher quantization accuracy means that more bits are used in the process of quantizing the L1-RSRP and/or differential L1-RSRP, and/or smaller step size is used in calculating the differential L1-RSRP. For example, in the new quantization scheme, the largest reported L1-RSRP value is defined by a 8-bit value (which is more than 7-bit) in the range [−140,−44] dBm with 0.5 dB step size, and the differential L1-RSRP is quantized to a 5-bit value or 6-bit value (which is more than 4-bit), which is computed with 1 dB step size or 0.5 dB step size (which is smaller than 2 dB step size) with a reference to the largest measured L1-RSRP value which is the largest reported L1-RSRP in the same beam report.

An example of the variety of the second embodiment is described. A UE is required to report the measurement results of all the 8 configured beams (K^{Beams}=8), i.e., 8 CSI-RS resources, included in the measurement beam set B. According to the measurement of the 8 configured beams by the UE, the fifth (i.e., (4+1)^{th} or 5^{th}) CSI-RS resource has the largest measured RSRP. In addition, the UE is indicated to use higher quantization accuracy. So, the CSI report reported by the UE is shown in Table 2. The bitwidth of CSI field is ┌log₂ (K^{Beams})┐=3 (where [x] means the smallest integer that is equal to or larger than x). The bitwidth of RSRP #1 of the CSI-RS resource (i.e., the largest reported RSRP) is 8 according to higher quantization accuracy. The bitwidth of differential RSRP is 5 according to higher quantization accuracy.

TABLE 2

| CSI report | | | |
|---|---|---|---|
| number | CSI field | Bitwidth | Interpretation |
| CSI report | CRI 4 | 3 | Indicating the (4 + 1)^{th} CSI-RS resource has the |
| #n | | | highest measured RSRP |
| | RSRP#1 of the | 8 | Indicating the measured RSRP of the (4 + 1)^{th} |
| | CSI-RS | | CSI-RS resource |
| | Differential | 5 | Indicating the RSRP of the 1^{st} CSI-RS |
| | RSRP#1 | | resource, which is the differential L1-RSRP |
| | | | computed with 1 dB step with a reference to |
| | | | the 5^{th} CSI-RS resource |
| | Differential | 5 | Indicating the RSRP of the 2^{nd} CSI-RS |
| | RSRP#2 | | resource, which is the differential L1-RSRP |
| | | | computed with 1 dB step with a reference to |
| | | | the 5^{th} CSI-RS resource |
| | Differential | 5 | Indicating the RSRP of the 3^{rd} CSI-RS |
| | RSRP#3 | | resource, which is the differential L1-RSRP |
| | | | computed with 1 dB step with a reference to |
| | | | the 5^{th} CSI-RS resource |
| | Differential | 5 | Indicating the RSRP of the 4^{th} CSI-RS |
| | RSRP#4 | | resource, which is the differential L1-RSRP |
| | | | computed with 1 dB step with a reference to |
| | | | the 5^{th} CSI-RS resource |
| | Differential | 5 | Indicating the RSRP of the 6^{th} CSI-RS |
| | RSRP#5 | | resource, which is the differential L1-RSRP |
| | | | computed with 1 dB step with a reference to |
| | | | the 5^{th} CSI-RS resource |
| | Differential | 5 | Indicating the RSRP of the 7^{th} CSI-RS |
| | RSRP#6 | | resource, which is the differential L1-RSRP |
| | | | computed with 1 dB step with a reference to |
| | | | the 5^{th} CSI-RS resource |
| | Differential | 5 | Indicating the RSRP of the 8^{th} CSI-RS |
| | RSRP#7 | | resource, which is the differential L1-RSRP |
| | | | computed with 1 dB step with a reference to |
| | | | the 5^{th} CSI-RS resource |

A third embodiment relates to beam report for AI/ML function deployed at UE side.

One or multiple AI/ML functions are deployed in a UE. As described in the first embodiment, each AI/ML function may have a different type. The AI/ML function with each type may be associated with a different CSI report configuration for beam report (i.e., CSI report contains beam ID(s) (i.e., CRI(s) or SSBRI(s)) and the L1-RSRP of the beams (i.e., CSI-RS or SSB resources) since the AI/ML function with a different type may have different inputs and/or different outputs. Each AI/ML function may correspond to one or more AI/ML models. It means that each CSI report configuration can be associated with a different type of the AI/ML function or be associated with an AI/ML model.

Generally, a CSI report configuration for beam report is associated with two resource sets, e.g., prediction beam set A comprising a set of beams (i.e., a set of CSI-RS or SSB resources) for prediction by the AI/ML inference function; and measurement beam set B comprising a set of beams (i.e., a set of CSI-RS or SSB resources) for measurement.

The beams in the prediction beam set A may not have to be explicitly configured in the CSI report configuration. It means that the beams in the prediction beam set A may be preconfigured to the UE as default beams in the prediction beam set A (i.e., a default prediction beam set A), since the number of the beams in the prediction beam set A may be large (e.g., 128 beams) and do not always change. In this condition, a CSI report configuration may indicate that the prediction beam set A associated with the CSI report configuration is the default prediction beam set A preconfigured to the UE, without the necessity to explicitly indicate the beams in the prediction beam set A.

The measurement beam set B configures a set of beams for the UE to measure and the measurement results (the measured RSRP of each beam in the measurement beam set B) are used as the input to the AI/ML function deployed at UE side. It means that the AI/ML function predicts the RSRP of each beam in the prediction beam set A according to the measured RSRP of each beam in the measurement beam set B. In other words, the UE only needs to measure the beams in measurement beam set B, and the UE does not need to measure the beams in prediction beam set A.

The beam report including a CSI report configuration requires the AI/ML function matches the CSI report configuration for the beam report. However, considering that the AI/ML function deployed at UE side that matches the CSI report configuration for the beam report may not be available at the time when the beam report is configured or triggered. For example, the AI/ML function may be in use by another beam report procedure. For another example, the AI/ML function may be inactive due to power saving. As a whole, it is possible that the UE cannot use the AI/ML function for the beam report as the NW configured.

In view of the above, this disclosure proposes that if the AI/ML function that matches the CSI report configuration for the beam report is not available, the UE is required to report the beam report based on the measured beams, i.e., based on the beams selected from the measurement beam set B (the detail of the beam report based on the measured beams will be discussed later).

To distinguish whether the reported beams in the beam report are the predicted beams selected from the prediction beam set A, or the measured beams selected from the measurement beam set B, a ‘beam type indication’ field is included in the beam report. For example, the ‘beam type indication’ field has 1 bit to indicate that the reported beams are measured beams or predicted beams.

In particular, if the ‘beam type indication’ field indicates that the reported beams are measured beams, the AI/ML model is not used while the reported beams are selected from the measurement beam set B. The bitwidth of the CRI or SSBRI field in the beam report, which indicates a CSI-RS resource or a SSB resource representing a beam, is determined by the number of beams (i.e., resources) configured in the measurement beam set B.

If the ‘beam type indication’ field indicates that the reported beams are predicted beams, the AI/ML model is used while the reported beams are selected from the prediction beam set A. The bitwidth of the CRI or SSBRI field in the beam report is determined by the number of beams (i.e., resources) configured in the prediction beam set A.

A first sub-embodiment of the third embodiment relates to the AI/ML function deployed at UE side for spatial domain beam prediction (i.e., only for spatial domain beam prediction, not for temporal domain beam prediction).

The CSI report configuration for a beam report for AI/ML function for spatial domain beam prediction is associated with measurement beam set B and prediction beam set A.

Upon receiving the CSI report configuration for a beam report associated with the AI/ML function for spatial domain beam prediction and the beam report being triggered, the UE measures the beams included in the measurement beam set B, provides the measurement result (i.e., the measured RSRP of each beam included in the measurement beam set B) along with the prediction beam set A as the input to the AI/ML function for spatial domain beam prediction, predicts (by the AI/ML function for spatial domain beam prediction) top K (K>=1) beams from the prediction beam set A, and reports the predicted top K beams in the beam report. The top K beams are K beams in the prediction beam set A that have K largest predicted RSRPs.

If the AI/ML function for spatial domain beam prediction is not available, the UE reports the top K measured beams in the beam report. The top K measured beams are K beams in the measurement beam set B that have K largest measured RSRPs.

A CSI report format according to the first sub-embodiment of the third embodiment is shown in Table 3. In Table 3, K=4.

TABLE 3

| CSI report | | | |
|---|---|---|---|
| number | CSI field | Bitwidth | Interpretation |
| CSI report | Beam type | 1 | Indicating the reported beams are measured |
| #n | indication | | beams or predicted beams |
| | CRI or SSBRI #1 | $⌈ {log}_{2} ( {K}_{m}^{Beams} ) ⌉$ | ${K}_{m}^{Beams} is the number of beams configured in the$ |
| | | or | $measurement beam set B and {K}_{p}^{Beams} is the$ |
| | | $⌈ {log}_{2} ( {K}_{p}^{Beams} ) ⌉$ | number of beams configured in the prediction |
| | CRI or SSBRI #2 | $⌈ {log}_{2} ( {K}_{m}^{Beams} ) ⌉$ | beam set A. |
| | | or | If the Beam type indication field indicates the |
| | | $⌈ {log}_{2} ( {K}_{p}^{Beams} ) ⌉$ | reported beams are measured beams, CRI or |
| | | | SSBRI field indicates beams selected from |
| | CRI or SSBRI #3 | $⌈ {log}_{2} ( {K}_{m}^{Beams} ) ⌉$ | measurement beam set B and the bitwidth of |
| | | or | $CRI or SSBRI field is ⌈ {log}_{2} ( {K}_{m}^{Beams} ) ⌉ , if the Beam$ |
| | | $⌈ {log}_{2} ( {K}_{p}^{Beams} ) ⌉$ | type indication field indicates the reported |
| | CRI or SSBRI #4 | $⌈ {log}_{2} ( {K}_{m}^{Beams} ) ⌉$ | beams are predicted beams, CRI or SSBRI field |
| | | or | indicates beams selected from measurement |
| | | $⌈ {log}_{2} ( {K}_{p}^{Beams} ) ⌉$ | beam set A and the bitwidth of CRI or SSBRI |
| | | | $field is ⌈ {log}_{2} ( {K}_{p}^{Beams} ) ⌉$ |
| | RSRP #1 | 7 | The RSRP of the beam corresponding to CRI or |
| | | | SSBRI #1. |
| | Differential | 4 | The differential RSRP of the beam |
| | RSRP #2 | | corresponding to CRI or SSBRI #2, which is |
| | | | computed with reference to beam corresponding |
| | | | to CSI or SSBRI #1. |
| | Differential | 4 | The differential RSRP of the beam |
| | RSRP #3 | | corresponding to CRI or SSBRI #3, which is |
| | | | computed with reference to beam corresponding |
| | | | to CSI or SSBRI #1. |
| | Differential | 4 | The differential RSRP of the beam |
| | RSRP #4 | | corresponding to CRI or SSBRI#4, which is |
| | | | computed with reference to beam corresponding |
| | | | to CSI or SSBRI #1. |

In Table 3, the RSRP of the beam corresponding to CRI or SSBRI #1 is the measured RSRP if the beam type indication field indicates the reported beams are measured beams, or is the predicted RSRP if the beam type indication field indicates the reported beams are predicted beams. Similarly, the differential RSRP of the beam corresponding to CRI or SSBRI #2, 3, or 4 is the differential measured RSRP if the beam type indication field indicates the reported beams are measured beams, or is the differential predicted RSRP if the beam type indication field indicates the reported beams are predicted beams. Differential RSRP based beam report specified in 3GPP TS38.214 and TS38.133 is adopted in Table 3.

A second sub-embodiment of the third embodiment relates to the AI/ML function deployed at UE side for both temporal domain beam prediction and spatial domain beam prediction.

The CSI report configuration for the beam report for AI/ML function for both temporal domain beam prediction and spatial domain beam prediction is associated with measurement beam set B and prediction beam set A.

Upon receiving the CSI report configuration for a beam report associated with the AI/ML function for both temporal domain beam prediction and spatial domain beam prediction and the beam report being triggered, the UE measures the beams included in the measurement beam set B, provides the measurement result (i.e., the measured RSRP of each beam included in the measurement beam set B) along with the prediction beam set A as the input to the AI/ML function for both temporal domain beam prediction and spatial domain beam prediction, predicts (by the AI/ML function for both temporal domain beam prediction and spatial domain beam prediction) top K (K>=1) beams from the prediction beam set A for F (F>=1) future time instances, and reports the predicted top K beams for each of F future time instances in the beam report. The top K beams for each of the F future time instances are K beams in the prediction beam set A that have K largest predicted RSRPs at each of the F future time instances.

If the AI/ML function for both temporal domain beam prediction and spatial domain beam prediction is not available, the UE reports the top K measured beams in the beam report. The top K beams are the K beams in the measurement beam set B that have K largest measured RSRPs.

A CSI report format according to the second sub-embodiment of the third embodiment, when AI/ML function for both temporal domain beam prediction and spatial domain beam prediction is used, is shown in Table 4. In Table 4, K=4

TABLE 4

| CSI report | | | |
|---|---|---|---|
| number | CSI field | Bitwidth | Interpretation |
| CSI report | Beam type | 1 | Beam type indication = '1' to indicate the |
| #n | indication | | reported beams are predicted beams |
| | CRI or SSBRI #1 for 1^{st} time | $⌈ {log}_{2} ( {K}_{p}^{Beams} ) ⌉$ | ${K}_{p}^{Beams} is the number of beams configured in the$ prediction beam set A. |
| | instance | | CRI or SSBRI field indicates beams predicted |
| | CRI or SSBRI #2 for 1^{st} time | $⌈ {log}_{2} ( {K}_{p}^{Beams} ) ⌉$ | from measurement beam set A and the bitwidth $of CSI or SSBRI field is ⌈ {log}_{2} ( {K}_{p}^{Beams} ) ⌉$ |
| | instance | | |
| | CRI or SSBRI #3 | $⌈ {log}_{2} ( {K}_{p}^{Beams} ) ⌉$ | |
| | for 1^{st} time | | |
| | instance | | |
| | CRI or SSBRI #4 | $⌈ {log}_{2} ( {K}_{p}^{Beams} ) ⌉$ | |
| | for 1^{st} time | | |
| | instance | | |
| | RSRP #1 | 7 | The predicted RSRP of the beam corresponding |
| | | | to CRI or SSBRI #1 for 1^{st} time instance. |
| | Differential | 4 | The differential predicted RSRP of the beam |
| | RSRP #2 | | corresponding to CRI or SSBRI #2 for 1^{st} time |
| | | | instance, which is computed with reference to |
| | | | beam corresponding to CSI or SSBRI #1 in 1st |
| | | | time instance. |
| | Differential | 4 | The differential predicted RSRP of the beam |
| | RSRP #3 | | corresponding to CRI or SSBRI #3 for 1^{st} time |
| | | | instance, which is computed with reference to |
| | | | beam corresponding to CSI or SSBRI #1 in 1^{st} |
| | | | time instance. |
| | Differential | 4 | The differential predicted RSRP of the beam |
| | RSRP #4 | | corresponding to CRI or SSBRI #4 for 1^{st} time |
| | | | instance, which is computed with reference to |
| | | | beam corresponding to CSI or SSBRI #1 in 1^{st} |
| | | | time instance. |
| | . . . | | |
| | CRI or SSBRI #1 for F^{th} time | $⌈ {log}_{2} ( {K}_{p}^{Beams} ) ⌉$ | ${K}_{p}^{Beams} is the number of beams configured in the$ prediction beam set A. |
| | instance | | When the Beam type indication field indicates |
| | CRI or SSBRI #2 for F^{th} time | $⌈ {log}_{2} ( {K}_{p}^{Beams} ) ⌉$ | the reported beams are predicted beams, CRI or SSBRI field indicates beams predicted from |
| | instance | | measurement beam set A and the corresponding |
| | CRI or SSBRI #3 for F^{th} time | $⌈ {log}_{2} ( {K}_{p}^{Beams} ) ⌉$ | $bitwidth of CRI or SSBRI field is ⌈ {log}_{2} ( {K}_{p}^{Beams} ) ⌉$ |
| | instance | | |
| | CRI or SSBRI #4 for F^{th} time | $⌈ {log}_{2} ( {K}_{p}^{Beams} ) ⌉$ | |
| | instance | | |
| | RSRP #1 | 7 | The predicted RSRP of the beam corresponding |
| | | | to CRI or SSBRI #1 for F^{th} time instance. |
| | Differential | 4 | The differential predicted RSRP of the beam |
| | RSRP #2 | | corresponding to CRI or SSBRI #2 for F^{th} time |
| | | | instance, which is computed with reference to |
| | | | beam corresponding to CSI or SSBRI #1 in F^{th} |
| | | | time instance. |
| | Differential | 4 | The differential predicted RSRP of the beam |
| | RSRP #3 | | corresponding to CRI or SSBRI #3 for F^{th} time |
| | | | instance, which is computed with reference to |
| | | | beam corresponding to CSI or SSBRI #1 in F^{th} |
| | | | time instance. |
| | Differential | 4 | The differential predicted RSRP of the beam |
| | RSRP #4 | | corresponding to CRI or SSBR I #4 for F^{th} time |
| | | | instance, which is computed with reference to |
| | | | beam corresponding to CSI or SSBR I #1 in F^{th} |
| | | | time instance. |

A CSI report format according to the second sub-embodiment of the third embodiment, when AI/ML function for both temporal domain beam prediction and spatial domain beam prediction is not used, is shown in Table 5. In Table 5, K=4.

TABLE 5

| CSI report | | | |
|---|---|---|---|
| number | CSI field | Bitwidth | Interpretation |
| CSI report | Beam type | 1 | Beam type indication = ‘0’ to indicate the |
| #n | indication | | reported beams are measured beams |
| | CRI or SSBRI #1 | $⌈ {log}_{2} ( {K}_{m}^{Beams} ) ⌉$ | ${K}_{m}^{Beams} is the number of beams configured in the$ |
| | CRI or SSBRI #2 | $⌈ {log}_{2} ( {K}_{m}^{Beams} ) ⌉$ | measurement beam set B (which is the same as |
| | CRI or SSBRI #3 | $⌈ {log}_{2} ( {K}_{m}^{Beams} ) ⌉$ | prediction beam set A). |
| | CRI or SSBRI #4 | $⌈ {log}_{2} ( {K}_{m}^{Beams} ) ⌉$ | CRI or SSBRI field indicates beams selected from measurement beam set B and the bitwidth |
| | | | $of CRI or SSBRI field is ⌈ {log}_{2} ( {K}_{m}^{Beams} ) ⌉$ |
| | RSRP #1 | 7 | The measured RSRP of the beam corresponding |
| | | | to CRI or SSBRI #1. |
| | Differential | 4 | The differential RSRP of the beam |
| | RSRP #2 | | corresponding to CRI or SSBRI #2, which is |
| | | | computed with reference to beam corresponding |
| | | | to CSI or SSBRI #1. |
| | Differential | 4 | The differential RSRP of the beam |
| | RSRP #3 | | corresponding to CRI or SSBR I #3, which is |
| | | | computed with reference to beam corresponding |
| | | | to CSI or SSBRI #1. |
| | Differential | 4 | The differential RSRP of the beam |
| | RSRP #4 | | corresponding to CRI or SSBRI #4, which is |
| | | | computed with reference to beam corresponding |
| | | | to CSI or SSBRI #1. |

In Table 4 and Table 5, the “Beam type indication” is set to ‘1’ to indicate the reported beams are predicted beams, and is set to ‘0’ to indicate the reported beams are measured beams. It is obvious that the “Beam type indication” is set to ‘0’ to indicate the reported beams are predicted beams, and is set to ‘1’ to indicate the reported beams are measured beams.

A third sub-embodiment of the third embodiment relates to the AI/ML function deployed at UE side only for temporal domain beam prediction (i.e., not for spatial domain beam prediction).

The CSI report configuration for the beam report for AI/ML function only for temporal domain beam prediction is associated with one beam set, which is used as both the measurement beam set B and the prediction beam set A. Since the beam report for AI/ML function only for temporal domain beam prediction can NOT make spatial domain beam prediction, the measurement beam set B is the same as prediction beam set A. It means that the AI/ML function only for temporal domain beam prediction makes prediction from the prediction beam set A that is same as the measurement beam set B.

Upon receiving the CSI report configuration for a beam report associated with the AI/ML function only for temporal domain beam prediction and the beam report being triggered, the UE measures the beams included in the measurement beam set B, provides the measurement result (i.e., the measured RSRP of each beam included in the measurement beam set B) as the input to the AI/ML function only for temporal domain beam prediction, predicts (by the AI/ML function only for temporal domain beam prediction) top K (K>=1) beams from the prediction beam set A (that is the same as the measurement beam set B) for F (F>=1) future time instances, and reports the predicted top K beams for each of F future time instances in the beam report. The top K beams for each of the F future time instances are K beams in the prediction beam set A that have K largest predicted RSRPs at each of the F future time instances.

If the AI/ML function only for temporal domain beam prediction is not available, the UE reports the top K measured beams in the beam report. The top K beams are the K beams in the measurement beam set B that have K largest measured RSRPs.

A CSI report format according to the third sub-embodiment of the third embodiment, when AI/ML function only for temporal domain beam prediction is used, is substantially the same as the CSI report format according to the second sub-embodiment of the third embodiment shown in Table 4.

The only “difference” is that, according to the third sub-embodiment of the third embodiment, the prediction beam set A is the same as measurement beam set B and

$${K}_{m}^{Beams} = {K}_{p}^{Beams} .$$

A CSI report format according to the third sub-embodiment of the third embodiment, when AI/ML function only for temporal domain beam prediction is not used, is the same as the CSI report format according to the second sub-embodiment of the third embodiment shown in Table 5.

In the description of the third embodiments, the legacy quantization scheme is used. It means that the largest reported RSRP is defined by a 7-bit value in the range [−140,−44] dBm with 1 dB step size, and the differential RSRP is quantized to a 4-bit value, while the differential RSRP is computed with 2 dB step size with a reference to the largest measured RSRP value which is the largest reported RSRP in the same beam report.

On the other hand, the CSI report configuration may be further associated with a higher quantization accuracy indication. The higher quantization accuracy means that more bits are used in the process of quantizing the L1-RSRP and/or differential L1-RSRP, and/or smaller step size are used in calculating the differential L1-RSRP. For example, in the new quantization scheme, the largest reported L1-RSRP value can be defined by a 8-bit value (which is more than 7-bit) in the range [−140,−44] dBm with 0.5 dB step size, and the differential L1-RSRP can be quantized to a 5-bit value or 6-bit value (which is more than 4-bit), which can be computed with 1 dB step size or 0.5 dB step size (which is smaller than 2 dB step size) with a reference to the largest measured L1-RSRP value which is the largest reported L1-RSRP in the same beam report.

A fourth embodiment relates to multi-stage beam measurement.

In the above-described third embodiment, each AI/ML function (AI/ML function for spatial domain beam prediction, AI/ML function for temporal domain beam prediction, and AI/ML function for both spatial domain beam prediction and temporal domain beam prediction) outputs IDs of top K beams with their predicted L1-RSRPs. This is referred to as AI/ML function output type 1.

For AI/ML function output type 2, the AI/ML function can only output IDs of top K beams (i.e., top K beams with higher probabilities). On the other hand, the AI/ML function can NOT predict the L1-RSRP of each of the top K beams. It means that if the AI/ML function has output type 2, it can only report the IDs of top K beams with higher probability to have the largest L1-RSRPs. However, from the network deployment point of view, the L1-RSRP may be more important than which beams are the top K beams with higher probability to have the largest L1-RSRPs.

In view of the above, the fourth embodiment proposes that a subsequent beam measurement and beam report procedure is expected to be triggered by the gNB, if the AI/ML function has output type 2.

The first embodiment describes that the UE reports all of the types of AI/ML function(s) equipped by the UE (or deployed at the UE). Considering that each type of AI/ML function may have different output types (output type 1 or output type 2), the type of an AI/ML function shall include both its function (for spatial domain beam prediction, for both temporal domain beam prediction and spatial domain beam prediction, and only for temporal domain beam prediction) and its output type (output type 1, output type 2).

A UE reports the capability that it has an AI/ML function with output type 2 (i.e., the AI/ML function can only output the best K beams with higher probabilities). The NW can configure a CSI report configuration, e.g., CSI report configuration #1, for a first beam report for the UE. The CSI report configuration is for the AI/ML model with output type 2, and is associated with a prediction beam set A as well as a measurement beam set B. Since the AI/ML model with output type 2 can only output the predicted beam ID. The first beam report (e.g., CSI report configuration #1) is further associated with another CSI report configuration, e.g., CSI report configuration #2, for a subsequent beam report (e.g., a second beam report). The CSI report configuration #2 shall be transmitted to the UE, e.g., via RRC signaling. The second beam report should be an aperiodic beam report which can be triggered by a control signal, e.g., by a DCI or a MAC CE.

The CSI report configuration #2 is associated with a second measurement beam set. The number of beams, i.e., CSI-RS or SSB resources, in the second measurement beam set is the same as the number of reported beam IDs configured for the first beam report (and which is reported in the first beam report).

A time duration or a window is defined since the transmission of the first beam report (e.g., beginning from the last symbol of the PUSCH or PUCCH carrying the first beam report corresponding to CSI report configuration #1).

If the UE receives a control signal (e.g., a DCI) within the time duration or the window to trigger the second beam report corresponding to CSI report configuration #2, the UE shall assume that the beams configured for CSI report configuration #2 are QCLed with the beams reported in the first beam report. It means that each beam with an index configured for CSI report configuration #2 is QCLed with the beam with the same index reported in the first beam report. A beam is QCLed with another beam means the UE can assume both beams are transmitted by a same spatial domain filter.

Otherwise (i.e., if the UE does not receive the control signal within the time duration or the window, which means that the UE receives a DCI out of the time duration or the window), the UE shall receive the beams configured for CSI report configuration #2 with the configured QCL information.

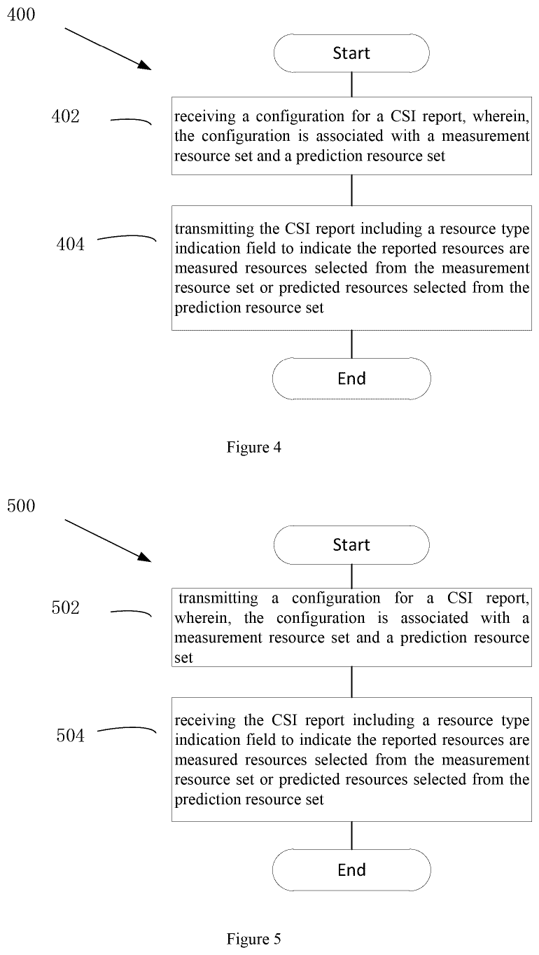

FIG. 4 is a schematic flow chart diagram illustrating an embodiment of a method 400 according to the present application. In some embodiments, the method 400 is performed by an apparatus, such as a remote unit (e.g., UE). In certain embodiments, the method 400 may be performed by a processor executing program code, for example, a microcontroller, a microprocessor, a CPU, a GPU, an auxiliary processing unit, a FPGA, or the like.

The method 400 is a method performed at a UE, comprising: 402 receiving a configuration for a CSI report, wherein, the configuration is associated with a measurement resource set and a prediction resource set; and 404 transmitting the CSI report including a resource type indication field to indicate the reported resources are measured resources selected from the measurement resource set or predicted resources selected from the prediction resource set.

In some embodiment, the configuration is associated with an AI/ML function at least for spatial domain resource prediction, if the resource type indication field indicates that the reported resources are predicted resources, the reported resources are predicted from the prediction resource set by the AI/ML function; and if the resource type indication field indicates that the reported resources are measured resources, the reported resources are resources in the measurement resource set that have top measured L1-RSRPs. In addition, if the resource type indication field indicates that the reported resources are predicted resources, a bitwidth of each CRI or SSBRI field in the CSI report is determined by the number of resources configured in the prediction resource set, and if the resource type indication field indicates that the reported resources are measured resources, the bitwidth of each CRI or SSBRI field in the CSI report is determined by the number of resources configured in the measurement resource set.

In some embodiment, the configuration is associated with an AI/ML function at least for temporal domain resource prediction, if the resource type indication field indicates that the reported resources are predicted resources, the reported resources are the predicted resources predicted by the AI/ML function for each of F future time instances, where Fis an integer that is 1 or more; and if the resource type indication field indicates that the reported resources are measured resources, the reported resources are resources in the measurement resource set that have top measured L1-RSRPs.

In some embodiment, the configuration is associated with an AI/ML function that can output predicted resources without predict L1-RSRPs of the predicted resources, the method further comprises receiving a configuration for a second CSI report which is associated with a second measurement resource set. The number of resources configured in the second measurement resource set may be the same as the number of reported resources in the CSI report. The method may further comprise receiving, within a duration since the transmission of the CSI report, a control signal triggering the second CSI report, wherein, the resources configured in the second measurement resource set are QCLed with the reported resources in the CSI report.

In some embodiment, the method further comprises transmitting information on the type(s) of the AI/ML function(s) equipped by the UE.

In some embodiment, the measurement resource set and the prediction resource set are the same resource set.

In some embodiment, the configuration is further associated with a quantization indication.

FIG. 5 is a schematic flow chart diagram illustrating an embodiment of a method 500 according to the present application. In some embodiments, the method 500 is performed by an apparatus, such as a base unit. In certain embodiments, the method 500 may be performed by a processor executing program code, for example, a microcontroller, a microprocessor, a CPU, a GPU, an auxiliary processing unit, a FPGA, or the like.

The method 500 may comprise 502 transmitting a configuration for a CSI report, wherein, the configuration is associated with a measurement resource set and a prediction resource set; and 504 receiving the CSI report including a resource type indication field to indicate the reported resources are measured resources selected from the measurement resource set or predicted resources selected from the prediction resource set.

In some embodiment, the configuration is associated with an AI/ML function at least for spatial domain resource prediction, if the resource type indication field indicates that the reported resources are predicted resources, the reported resources are predicted from the prediction resource set by the AI/ML function; and if the resource type indication field indicates that the reported resources are measured resources, the reported resources are resources in the measurement resource set that have top measured L1-RSRPs. In addition, if the resource type indication field indicates that the reported resources are predicted resources, a bitwidth of each CRI or SSBRI field in the CSI report is determined by the number of resources configured in the prediction resource set, and if the resource type indication field indicates that the reported resources are measured resources, the bitwidth of each CRI or SSBRI field in the CSI report is determined by the number of resources configured in the measurement resource set.

In some embodiment, the configuration is associated with an AI/ML function at least for temporal domain resource prediction, if the resource type indication field indicates that the reported resources are predicted resources, the reported resources are the predicted resources predicted by the AI/ML function for each of F future time instances, where F is an integer that is 1 or more; and if the resource type indication field indicates that the reported resources are measured resources, the reported resources are resources in the measurement resource set that have top measured L1-RSRPs.

In some embodiment, the configuration is associated with an AI/ML function that can output predicted resources without predict L1-RSRPs of the predicted resources, the method further comprises transmitting a configuration for a second CSI report which is associated with a second measurement resource set. The number of resources configured in the second measurement resource set may be the same as the number of reported resources in the CSI report. The method may further comprise transmitting within a duration since the reception of the CSI report a control signal triggering the second CSI report, wherein, the resources configured in the second measurement resource set are QCLed with the reported resources in the CSI report.

In some embodiment, the method further comprises receiving information on the type(s) of the AI/ML function(s) equipped by UE.

In some embodiment, the measurement resource set and the prediction resource set are the same resource set.

In some embodiment, the configuration is further associated with a quantization indication.

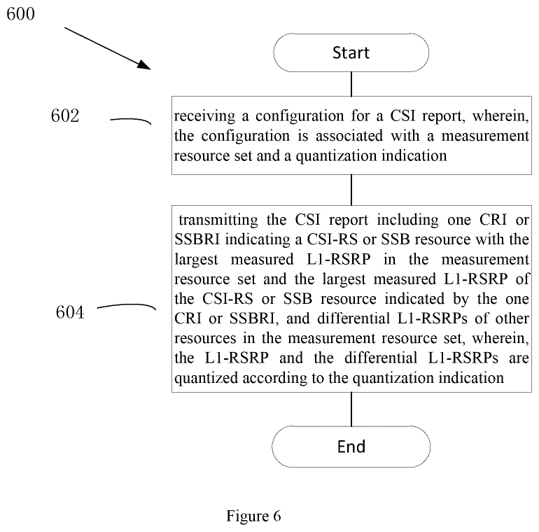

FIG. 6 is a schematic flow chart diagram illustrating an embodiment of a method 600 according to the present application. In some embodiments, the method 600 is performed by an apparatus, such as a remote unit (e.g., UE). In certain embodiments, the method 600 may be performed by a processor executing program code, for example, a microcontroller, a microprocessor, a CPU, a GPU, an auxiliary processing unit, a FPGA, or the like.

The method 600 is a method performed at a UE, comprising: 602 receiving a configuration for a CSI report, wherein, the configuration is associated with a measurement resource set and a quantization indication; and 604 transmitting the CSI report including one CRI or SSBRI indicating a CSI-RS or SSB resource with the largest measured L1-RSRP in the measurement resource set and the largest measured L1-RSRP of the CSI-RS or SSB resource indicated by the one CRI or SSBRI, and differential L1-RSRPs of other resources in the measurement resource set, wherein, the L1-RSRP and the differential L1-RSRPs are quantized according to the quantization indication.

In some embodiment, the quantization indication defines a 8-bit value for the largest measured L1-RSRP, and a 5-bit value or 6-bit value for the differential L1-RSRP with respect to the largest measured L1-RSRP, wherein the 8-bit value represents a range of [−140,−44] dbm with 0.5 dB step size, and the 5-bit value or 6-bit value represents 1 dB step size or 0.5 dB step size.

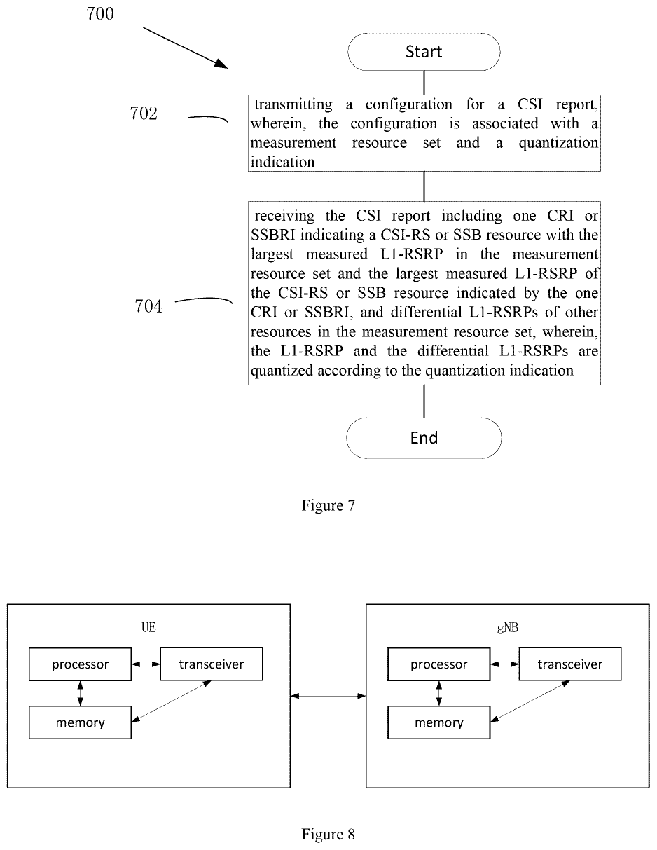

FIG. 7 is a schematic flow chart diagram illustrating an embodiment of a method 700 according to the present application. In some embodiments, the method 700 is performed by an apparatus, such as a base unit. In certain embodiments, the method 700 may be performed by a processor executing program code, for example, a microcontroller, a microprocessor, a CPU, a GPU, an auxiliary processing unit, a FPGA, or the like.

The method 700 may comprise 702 transmitting a configuration for a CSI report, wherein, the configuration is associated with a measurement resource set and a quantization indication; and 704 receiving the CSI report including one CRI or SSBRI indicating a CSI-RS or SSB resource with the largest measured L1-RSRP in the measurement resource set and the largest measured L1-RSRP of the CSI-RS or SSB resource indicated by the one CRI or SSBRI, and differential L1-RSRPs of other resources in the measurement resource set, wherein, the L1-RSRP and the differential L1-RSRPs are quantized according to the quantization indication.

In some embodiment, the quantization indication defines a 8-bit value for the largest measured L1-RSRP, and a 5-bit value or 6-bit value for the differential L1-RSRP with respect to the largest measured L1-RSRP, wherein the 8-bit value represents a range of [−140,−44] dbm with 0.5 dB step size, and the 5-bit value or 6-bit value represents 1 dB step size or 0.5 dB step size.

FIG. 8 is a schematic block diagram illustrating apparatuses according to one embodiment.

Referring to FIG. 8, the UE (i.e., the remote unit) includes a processor, a memory, and a transceiver. The processor implements a function, a process, and/or a method which are proposed in FIG. 4 or 6.

A first UE comprises a transceiver; and a processor coupled to the transceiver, wherein the processor is configured to receive, via the transceiver, a configuration for a CSI report, wherein, the configuration is associated with a measurement resource set and a prediction resource set; and transmit, via the transceiver, the CSI report including a resource type indication field to indicate the reported resources are measured resources selected from the measurement resource set or predicted resources selected from the prediction resource set.

In some embodiment, the configuration is associated with an AI/ML function at least for spatial domain resource prediction, if the resource type indication field indicates that the reported resources are predicted resources, the reported resources are predicted from the prediction resource set by the AI/ML function; and if the resource type indication field indicates that the reported resources are measured resources, the reported resources are resources in the measurement resource set that have top measured L1-RSRPs. In addition, if the resource type indication field indicates that the reported resources are predicted resources, a bitwidth of each CRI or SSBRI field in the CSI report is determined by the number of resources configured in the prediction resource set, and if the resource type indication field indicates that the reported resources are measured resources, the bitwidth of each CRI or SSBRI field in the CSI report is determined by the number of resources configured in the measurement resource set.

In some embodiment, the configuration is associated with an AI/ML function at least for temporal domain resource prediction, if the resource type indication field indicates that the reported resources are predicted resources, the reported resources are the predicted resources predicted by the AI/ML function for each of F future time instances, where F is an integer that is 1 or more; and if the resource type indication field indicates that the reported resources are measured resources, the reported resources are resources in the measurement resource set that have top measured L1-RSRPs.

In some embodiment, the configuration is associated with an AI/ML function that can output predicted resources without predict L1-RSRPs of the predicted resources, the processor is further configured to receive, via the transceiver, a configuration for a second CSI report which is associated with a second measurement resource set. The number of resources configured in the second measurement resource set may be the same as the number of reported resources in the CSI report. The processor may be further configured to receive, via the transceiver, within a duration since the transmission of the CSI report, a control signal triggering the second CSI report, wherein, the resources configured in the second measurement resource set are QCLed with the reported resources in the CSI report.

In some embodiment, the processor is further configured to transmit, via the transceiver, information on the type(s) of the AI/ML function(s) equipped by the UE.

In some embodiment, the measurement resource set and the prediction resource set are the same resource set.

In some embodiment, the configuration is further associated with a quantization indication.

A second UE comprises a transceiver; and a processor coupled to the transceiver, wherein the processor is configured to receive, via the transceiver, a configuration for a CSI report, wherein, the configuration is associated with a measurement resource set and a quantization indication; and transmit, via the transceiver, the CSI report including one CRI or SSBRI indicating a CSI-RS or SSB resource with the largest measured L1-RSRP in the measurement resource set and the largest measured L1-RSRP of the CSI-RS or SSB resource indicated by the one CRI or SSBRI, and differential L1-RSRPs of other resources in the measurement resource set, wherein, the L1-RSRP and the differential L1-RSRPs are quantized according to the quantization indication.

In some embodiment, the quantization indication defines a 8-bit value for the largest measured L1-RSRP, and a 5-bit value or 6-bit value for the differential L1-RSRP with respect to the largest measured L1-RSRP, wherein the 8-bit value represents a range of [−140,−44] dbm with 0.5 dB step size, and the 5-bit value or 6-bit value represents 1 dB step size or 0.5 dB step size.

The gNB (i.e., the base unit) includes a processor, a memory, and a transceiver. The processor implements a function, a process, and/or a method which are proposed in FIG. 5 or 7.

A first base unit comprises a transceiver; and a processor coupled to the transceiver, wherein the processor is configured to transmit, via the transceiver, a configuration for a CSI report, wherein, the configuration is associated with a measurement resource set and a prediction resource set; and receive, via the transceiver, the CSI report including a resource type indication field to indicate the reported resources are measured resources selected from the measurement resource set or predicted resources selected from the prediction resource set.

In some embodiment, the configuration is associated with an AI/ML function at least for spatial domain resource prediction, if the resource type indication field indicates that the reported resources are predicted resources, the reported resources are predicted from the prediction resource set by the AI/ML function; and if the resource type indication field indicates that the reported resources are measured resources, the reported resources are resources in the measurement resource set that have top measured L1-RSRPs. In addition, if the resource type indication field indicates that the reported resources are predicted resources, a bitwidth of each CRI or SSBRI field in the CSI report is determined by the number of resources configured in the prediction resource set, and if the resource type indication field indicates that the reported resources are measured resources, the bitwidth of each CRI or SSBRI field in the CSI report is determined by the number of resources configured in the measurement resource set.

In some embodiment, the configuration is associated with an AI/ML function at least for temporal domain resource prediction, if the resource type indication field indicates that the reported resources are predicted resources, the reported resources are the predicted resources predicted by the AI/ML function for each of F future time instances, where Fis an integer that is 1 or more; and if the resource type indication field indicates that the reported resources are measured resources, the reported resources are resources in the measurement resource set that have top measured L1-RSRPs.

In some embodiment, the configuration is associated with an AI/ML function that can output predicted resources without predict L1-RSRPs of the predicted resources, the processor is further configured to transmit, via the transceiver, a configuration for a second CSI report which is associated with a second measurement resource set. The number of resources configured in the second measurement resource set may be the same as the number of reported resources in the CSI report. The processor may be further configured to transmit, via the transceiver, within a duration since the reception of the CSI report, a control signal triggering the second CSI report, wherein, the resources configured in the second measurement resource set are QCLed with the reported resources in the CSI report.

In some embodiment, the processor is further configured to receive, via the transceiver, information on the type(s) of the AI/ML function(s) equipped by UE.

In some embodiment, the measurement resource set and the prediction resource set are the same resource set.

In some embodiment, the configuration is further associated with a quantization indication.

A second base unit comprises a transceiver; and a processor coupled to the transceiver, wherein the processor is configured to transmit, via the transceiver, a configuration for a CSI report, wherein, the configuration is associated with a measurement resource set and a quantization indication; and receive, via the transceiver, the CSI report including one CRI or SSBRI indicating a CSI-RS or SSB resource with the largest measured L1-RSRP in the measurement resource set and the largest measured L1-RSRP of the CSI-RS or SSB resource indicated by the one CRI or SSBRI, and differential L1-RSRPs of other resources in the measurement resource set, wherein, the L1-RSRP and the differential L1-RSRPs are quantized according to the quantization indication.

In some embodiment, the quantization indication defines a 8-bit value for the largest measured L1-RSRP, and a 5-bit value or 6-bit value for the differential L1-RSRP with respect to the largest measured L1-RSRP, wherein the 8-bit value represents a range of [−140,−44] dbm with 0.5 dB step size, and the 5-bit value or 6-bit value represents 1 dB step size or 0.5 dB step size.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive, a configuration for a channel state information (CSI) report, wherein the configuration is associated with a measurement resource set and a prediction resource set; and
transmit the CSI report including a resource type indication field to indicate reported resources are measured resources selected from the measurement resource set or predicted resources selected from the prediction resource set.

2. The UE of claim 1, wherein the configuration is associated with an artificial intelligence/machine learning (AI/ML) function at least for spatial domain resource prediction, and
if the resource type indication field indicates that the reported resources are predicted resources, the reported resources are predicted from the prediction resource set by the AI/ML function; or
if the resource type indication field indicates that the reported resources are measured resources, the reported resources are resources in the measurement resource set that have top measured Layer 1 Reference Signal Receiving Powers (L1-RSRPs).

3. The UE of claim 2, wherein,
if the resource type indication field indicates that the reported resources are predicted resources, a bitwidth of each Channel State Information Reference Signal (CSI-RS) resource indicator (CRI) or synchronization signal block resource indicator (SSBRI) field in the CSI report is determined by the number of resources configured in the prediction resource set, and
if the resource type indication field indicates that the reported resources are measured resources, the bitwidth of each CRI or SSBRI field in the CSI report is determined by the number of resources configured in the measurement resource set.

4. The UE of claim 1, wherein the configuration is associated with an artificial intelligence/machine learning (AI/ML) function at least for temporal domain resource prediction, and
if the resource type indication field indicates that the reported resources are predicted resources, the reported resources are the predicted resources predicted by the AI/ML function for each of F future time instances, where Fis an integer that is 1 or more; and
if the resource type indication field indicates that the reported resources are measured resources, the reported resources are resources in the measurement resource set that have top measured Layer 1 Reference Signal Receiving Powers (L1-RSRPs).

5. The UE of claim 1, wherein the configuration is associated with an artificial intelligence/machine learning (AI/ML) function that can output predicted resources without predict Layer 1 Reference Signal Receiving Powers (L1-RSRPs) of the predicted resources, and
wherein the at least one processor is further configured to cause the UE to receive a configuration for a second CSI report associated with a second measurement resource set.

6. The UE of claim 1, wherein the number of resources configured in the second measurement resource set is the same as the number of reported resources in the CSI report.

7. The UE of claim 5, wherein
the at least one processor is further configured to cause the UE to receive, within a duration since the transmission of the CSI report, a control signal triggering the second CSI report, wherein the resources configured in the second measurement resource set are quasi co-located (QCLed) with the reported resources in the CSI report.

8. The UE of claim 1, wherein
the at least one processor is further configured to cause the UE to transmit information associated with the type of artificial intelligence/machine learning (AI/ML) functions equipped by the UE.

9. The UE of claim 1, wherein the measurement resource set and the prediction resource set are the same resource set.

10. The UE of claim 1, wherein the configuration is associated with a quantization indication.

11. A method performed by a user equipment (UE), the method comprising:
receiving a configuration for a channel state information (CSI) report, wherein the configuration is associated with a measurement resource set and a prediction resource set; and
transmitting the CSI report including a resource type indication field to indicate the reported resources are measured resources selected from the measurement resource set or predicted resources selected from the prediction resource set.

12. (canceled)

13. The method of claim 11, wherein the configuration is associated with an artificial intelligence/machine learning (AI/ML) function at least for spatial domain resource prediction, and
if the resource type indication field indicates that the reported resources are predicted resources, the reported resources are predicted from the prediction resource set by the AI/ML function; or
if the resource type indication field indicates that the reported resources are measured resources, the reported resources are resources in the measurement resource set that have top measured Layer 1 Reference Signal Receiving Powers (L1-RSRPs).

14. The method of claim 11, wherein,
if the resource type indication field indicates that the reported resources are predicted resources, a bitwidth of each Channel State Information Reference Signal (CSI-RS) resource indicator (CRI) or synchronization signal block resource indicator (SSBRI) field in the CSI report is determined by the number of resources configured in the prediction resource set, and
if the resource type indication field indicates that the reported resources are measured resources, the bitwidth of each CRI or SSBRI field in the CSI report is determined by the number of resources configured in the measurement resource set.

15. The method of claim 11, wherein the configuration is associated with an artificial intelligence/machine learning (AI/ML) function at least for temporal domain resource prediction, and
if the resource type indication field indicates that the reported resources are predicted resources, the reported resources are the predicted resources predicted by the AI/ML function for each of F future time instances, where F is an integer that is 1 or more; and
if the resource type indication field indicates that the reported resources are measured resources, the reported resources are resources in the measurement resource set that have top measured Layer 1 Reference Signal Receiving Powers (L1-RSRPs).

16. The method of claim 11, wherein the configuration is associated with an artificial intelligence/machine learning (AI/ML) function that can output predicted resources without predict Layer 1 Reference Signal Receiving Powers (L1-RSRPs) of the predicted resources, and
wherein the at least one processor is further configured to cause the UE to receive a configuration for a second CSI report associated with a second measurement resource set.

17. The method of claim 11, wherein the number of resources configured in the second measurement resource set is the same as the number of reported resources in the CSI report.

18. The method of claim 11, further comprising: transmitting information associated with the type of artificial intelligence/machine learning (AI/ML) functions equipped by the UE.

19. The method of claim 11, wherein the measurement resource set and the prediction resource set are the same resource set.

20. A base station (BS) for wireless communication, comprising:
at least one memory; and
at least one processor coupled with the at least one memory and configured to cause the BS to:
transmit a configuration for a channel state information (CSI) report, wherein the configuration is associated with a measurement resource set and a prediction resource set; and
receive the CSI report including a resource type indication field that indicates reported resources are measured resources selected from the measurement resource set or predicted resources selected from the prediction resource set.

21. A method performed by a base station (BS), the method comprising:
transmitting a configuration for a channel state information (CSI) report, wherein the configuration is associated with a measurement resource set and a prediction resource set; and
receiving the CSI report including a resource type indication field that indicates reported resources are measured resources selected from the measurement resource set or predicted resources selected from the prediction resource set.
